(19) United States
(12) Patent Application Publication
(10) Pub. No.: US 2014/0117782 A1
(43) Pub. Date: May 1, 2014

(54) SYSTEM AND DEVICE FOR REPLACING MECHANICAL ACTUATORS WITH TOUCH-FREE ACTUATORS IN A 2-WIRE ACTIVATION SYSTEM

(71) Applicants: Leroy Wignot, Carmel, IN (US); Brian Christopher, McCordsville, IN (US); William Gudgel, Indiana, IN (US); Larry Pryor, Carmel, IN (US); Eric Arthur, Brownsburg, IN (US)

(72) Inventors: Leroy Wignot, Carmel, IN (US); Brian Christopher, McCordsville, IN (US); William Gudgel, Indiana, IN (US); Larry Pryor, Carmel, IN (US); Eric Arthur, Brownsburg, IN (US)

(21) Appl. No.: 13/664,801

(22) Filed: Oct. 31, 2012

(51) Int. Cl. H01H 47/00

(52) U.S. Cl. CPC H01H 47/00
USPC 307/131

(57) ABSTRACT

A system, kit and/or device is provided for replacing mechanical actuators with touch-less actuators in a 2-wire automatic door system. The system, kit and/or device includes a sensor module connectable to power and the motor and control for the door, and one or more touch-less switches each configured for electrical connection with the sensor module via two wires. The sensor module is operable to sense change in current by the touch-less switches, caused by actuation thereof to send a signal to the door motor and control for opening the door. The module conditions the voltage to give +12 volts to each of two touch-less switches. Current in each touch-less switch is one current for idle or another current when activated. This difference in current is sensed at the sensor module through the two wires. When the extra current is sensed a control signal to open the door is sent to the door motor control.

### FIELD OF THE INVENTION

The present invention relates to electrical systems activated by mechanical actuators and, more particularly, to replacement of mechanical actuators in such electrical systems with touch-free actuators, for instance in automatic door operating systems.

### BACKGROUND

Commercial facilities, hospitals, institutions and the like (collectively, facilities) all want to decrease the spread of illness and disease by attempting to minimize contact, with common touch points or places within the facility. The less people touch a surface, the less likely they will come in contact with undesirable gems, viruses, bacteria and the like that can cause illness and disease. One extremely common touch point, particularly in hospitals, is the mechanical switch for opening an automatic door. Each time the door is opened, the mechanical switch must be touched.

It has been recognized that by changing the existing touch (mechanical) switches to touch-less or touch-free switches, a major contact point can be eliminated. Elimination of a major contact point would thus minimize the spread of illness and disease.

A typical prior art hardwired automatic door opening and closing system 10 is depicted in FIG. 1. The system 10 automatically opens a door 12 upon actuation of one of two touch (mechanical) switches SW 16a and SW 16b it being appreciated that the system may have only one switch SW or more than two switches SW. A motor and control 14 is operatively connected to an A/C electricity source 13 and the door 12 for automatically opening the door 12 upon the control 14 receiving a signal from one of the switches SW 16a, 16b when touched. Since the switches SW 16a. 16b are mechanical, they require only 2 wires for connection to the control 14. As such, the touch switch SW 16a is electrically connected to the motor and control 14 via 2 wire electrical connection 17a, while the touch switch SW 16b is electrically connected to the motor and control 14 via 2-wire electrical connection 17b. The two wires run to each switch to open the door.

However, in order to install a touch-less switch in place of or instead of the mechanical or touch switch, four wires are required to electrically connect the touch-less switch to the motor and control for the door—i.e. two wires for power and two wires for touch-less switch activation. This means that two additional wires would need to be run. Running the extra/additional wires is often difficult, expensive, time consuming, and maybe not even practical in a facility that is already built.

It is thus apparent from the above that there exists a need for a system, kit, and/or device for replacing mechanical actuators with touch-less actuators in a 2-wire activation system.

### SUMMARY OF THE INVENTION

The present invention is a system, kit and/or device for replacing mechanical actuators with touch-less actuators in a 2-wire activation system. The system, kit and/or device includes a sensor module connectable to power and an activation system such as a door opener, and one or more touch-less actuator each configured for electrical connection with the sensor module via two wires. The sensor module is operable to sense an electrical condition caused by actuation of one of the touch-less actuators to send a signal to the door and control for opening the door.

In one form, the touch-less actuator is configured to use a first amount of current during an idle state (i.e. when no activation signal is received) and a second amount of current during activation that is greater than the first amount of current. The sensor module is then configured to monitor and sense when the current goes from the first amount of current to the second amount of current for a given touch-less actuator. A relay of the sensor module is in electrical communication with the touch-less actuators such that a supply current from the relay to an activated touch-less actuator increases. The relay provides a predictable amount of current that is sensed by the sensor module.

A typical first amount of current is around 10 mA while the second amount, of current is around 50 mA. A resistive load may be added to the relays to draw more current when a touch-less actuator is activated.

In one form, the sensor module power requirement is 12-24V AC or DC. The sensor module conditions the voltage to give 12 volts to each of two touch-less switches. The current in each touch-less sensor is either 10 mA for idle or 50 mA when activated. This difference in current is sensed back at the sensor module through two wires. When the extra current is sensed a control signal to open the door is sent to the door motor control.

In one form, the touch-less switches may allow adjustable reaction time—i.e. the time from when someone places a hand in front of the switch until it sends its output. Thus, if a switch is placed in a crowded space where inadvertent activations are a concern or problem, reaction time can be increased, requiring users to hold their hands in front of the touch-less switch for a longer time for activation to occur.

### BRIEF DESCRIPTION OF THE DRAWINGS

The above mentioned and other features, advantages and object of this invention, and the manner of attaining them, will become apparent and the invention itself will be better understood by reference to the following description of an embodiment of the invention taken in conjunction with the accompanying drawings, wherein:

FIG. 1 is a diagrammatic representation of a prior art door opening system using mechanical actuators each one of which is connected via two wires to a door motor and control that operates the door motor in order to open and close the door;

FIG. 2 is a diagrammatic representation of the door opening system of FIG. 1 retrofitted with touch-free actuators each one of which is connected via the existing two wires to a sensor module of the present invention that is then connected to the door motor and control;

FIG. 3 is an enlarged view of an exemplary embodiment of the sensor module of the present invention;

FIG. 4 is an electrical schematic of exemplary electrical sensing circuitry of the sensor module of the present invention; and

FIG. 5 is a screen capture of a computer running a SPICE simulation on a basic portion of the present electrical sensing circuitry in order to verify basic theory and operation of the present invention.

Like reference numerals indicate the same or similar parts throughout the several figures.

A description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION

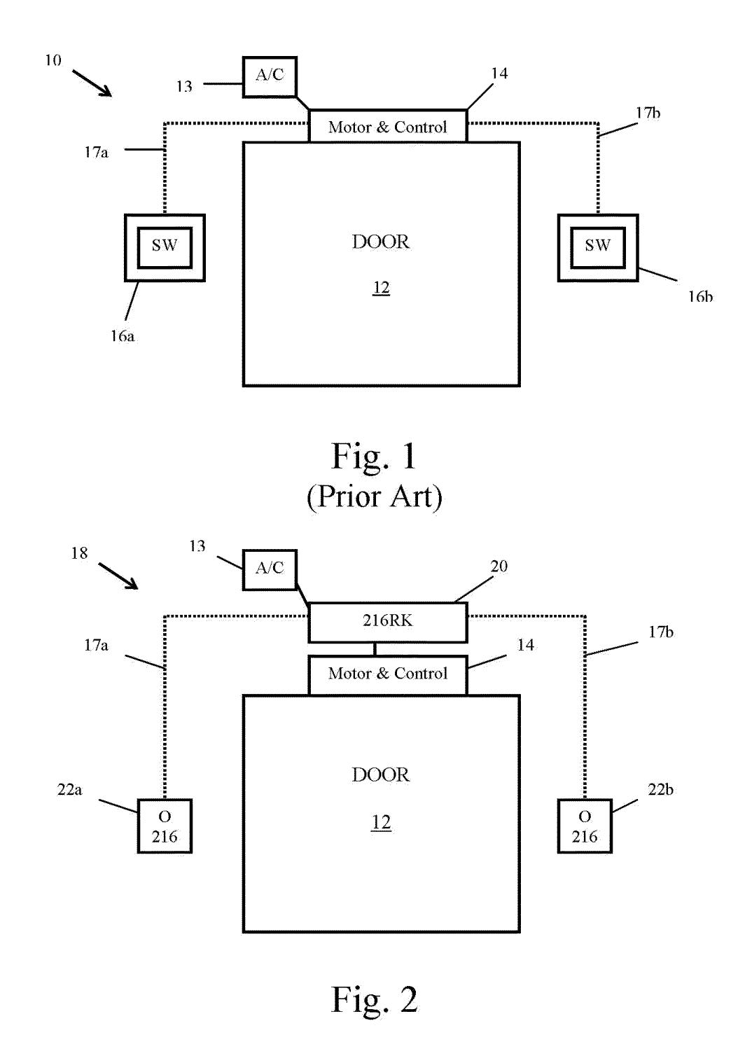

Referring to FIG. 2, there is depicted a diagrammatic representation 18 of the hardwired automatic door opening and closing system as depicted in FIG. 1 but retrofitted with the present invention. Particularly, the mechanical touch switch or actuator SW 16a has been replaced with a touch-less switch 22a while the, mechanical touch switch or actuator SW 16b has been replaced with a touch-less switch 22b, both of which are preferably, but not necessarily, a model 216 touch-less switches/actuators from MS Sedco of Indianapolis, Ind. The touch-less switches 22a, 22b are configured to operate using only two wires. Thus, the touch-less switch 22a is connected to the two-wire electrical connection 17a, while the touch-less switch 22b is connected to the two-wire electrical connection 17b.

The present system, kit and/or device further includes a sensor module 20 that is connected to power 13 and the door motor and control 14, the sensor module 20 being preferably, but not necessarily, a model 216-RK sensor module from MS Sedco of Indianapolis, Ind. The two-wire electrical connections 17a, 17b from the touch-less switches 22a, 22b are electrically connected to the sensor module 20. The sensor module 20 monitors and/or senses a change in an electrical parameter or condition of the circuit and/or a touch-less switch when a touch-less-switch is activated. In the present case, the sensor module 20 senses a change in current, indicating that a touch-less switch has been activated.

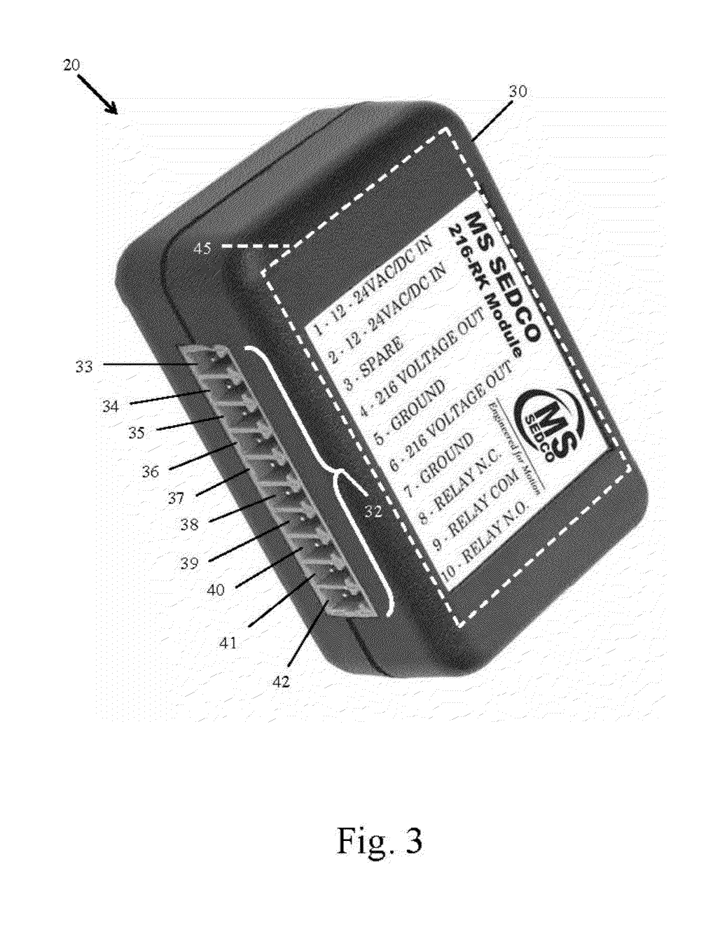

An exemplary sensor module 20 is depicted in FIG. 3 and attention is drawn thereto. The sensor module 20 designed to electrically connect to existing automatic door openers (i.e. motors and/or motor control or controller 14), to electricity (i.e. A/C electricity 13) and the two touch-less switches or actuators 22a 22b via the respective two-wire electrical connections 17a, 17b. The sensor module 20 has a case 30 that houses electrical circuitry/logic 45 for receiving, conditioning and distributing incoming electricity, sensing current relative to each one of the two touch-less switches 22a, 22b, and outputting an activation signal when one of the touch-less switches 22a, 22b has been actuated (i.e. when a rise in current is senses). The case 30 supports a plurality of jacks or pins 32 for providing electrical connections to and from the electrical circuitry/logic 45 of the sensor module 20.

Particularly, the case 30 supports ten (10) inputs/outputs 33-42. The case 30 carries a decal or the like labeling the various jacks or pins 33-42. Jacks 33 and 34 are for providing 12-24 volts AC/DC IN to the circuitry 45 which is common in the door industry. Jack 35 is currently not used (i.e. “Spare”). Jack 36 is a voltage output to the first touch-less “216” switch 22a, while jack 37 is ground to the first touch-less switch 22a. Jack 38 is a voltage output to the second touch-less “216” switch 22b, while jack 39 is ground to the second touch-less switch 22b. Jack 40 is the relay normally open output, jack 42 is the relay normally closed output, and jack 41 is the relay common output.

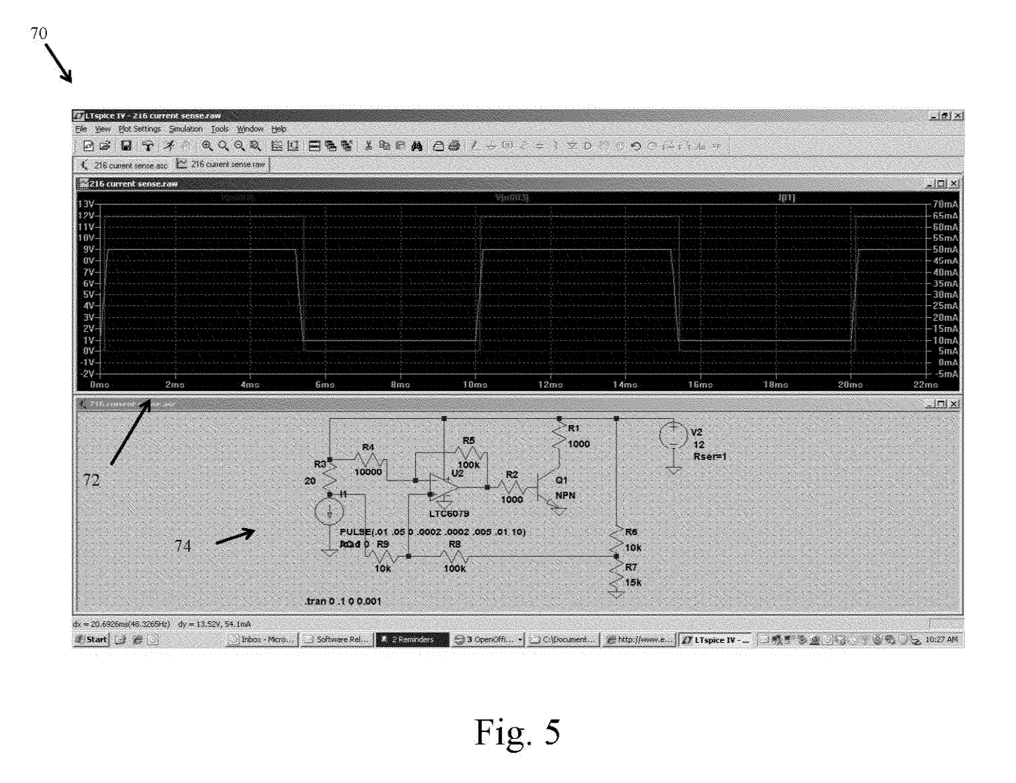

The sensor module 20 utilizes an op amp configuration for sensing current in a load (i.e. a touch-less switch 22a, 22b) along with a relay for controlling the motor control when an op amp senses a rise in current. As shown in FIG. 5, an exempla high-side op amp circuit 74 using op amp U2 for sensing current change in a two-wire load is being tested via SPICE 70 electrical simulation software. The output of the circuit 74 is charted in the top panel 72 wherein green is the current through the current sense resistor, red is the output of the collector, and blue is the output of the op amp. The simulation confirms operation of the circuit 74 and thus the theory.

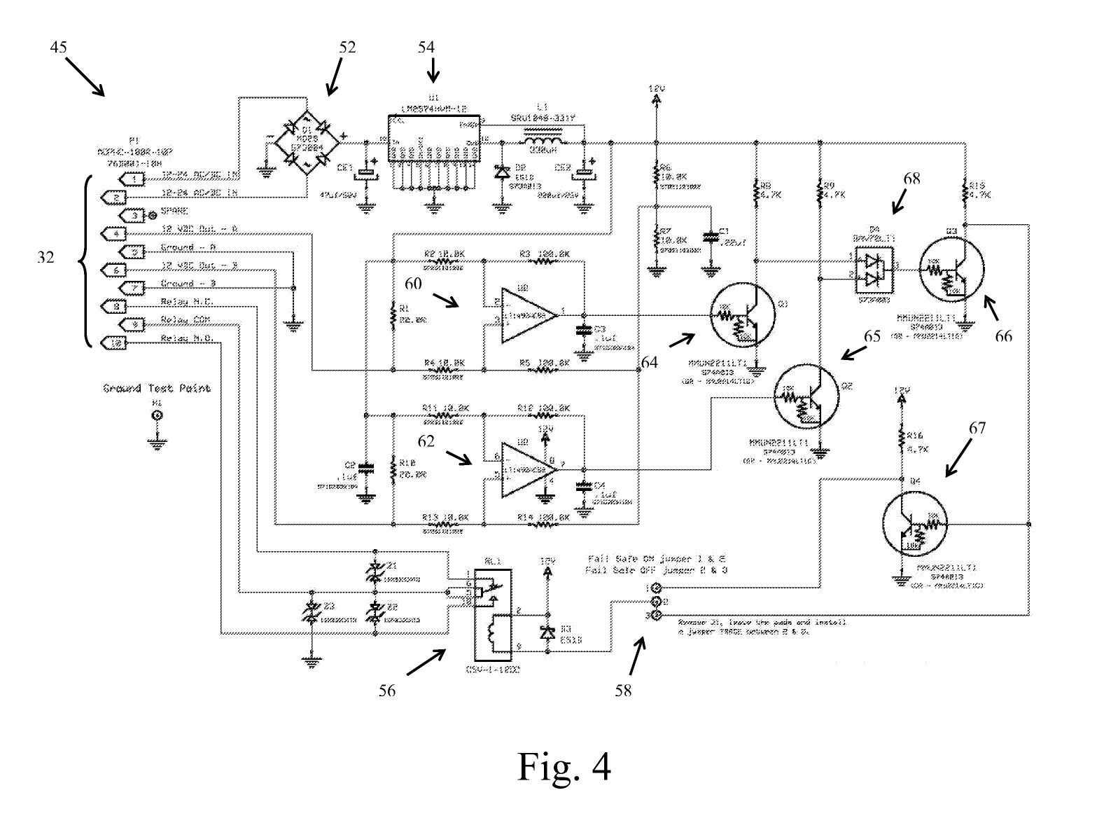

Referring now to FIG. 4, there is shown an electrical schematic of the electrical circuitry/logic 45 for the sensor module 20. The electrical schematic is exemplary of a manner of sensing current change in a two-wire touch-less switch and outputting an activation signal, it being understood that the principles of the present invention may be embodied in variations. The plurality of inputs/outputs 32 of the sensor module as shown and described in FIG. 3 is shown in the left hand side of FIG. 4. The power requirement for the present circuitry is 12-24V AC or DC. This voltage is provided to a bridge rectifier 52 and voltage regulator circuitry 54 in order to provide a regulated +12 volts to the sensor module.

There are two independent current sense circuits, one for each touch-less sensor 22a and 22b. A current sensor 60, formed with upper op amp U2, is configured for high-side current sensing of one of the touch-less switches by providing its output to output A (12V DC Out-A), jack 36, that connects to one wire of the touch-less sensor. A current sensor 62, formed with lower op amp U2, is configured for high-side current sensing of the other of the touch-less switches by its output to output B (12V DC Out-B) jack 38, that connects to one wire of the touch-less sensor. The primary regulated +12 volt supply goes through sense resistors R1 and R10 out to each of the touch-less switches.

Each touch-less switch receives the supply voltage through one wire of its two wire electrical connection while connected to a ground return via the other wire of its two wire electrical connection. A relay in each 216 is provided to create a current draw (i.e. current increase) in the circuit when a touch-less switch is actuated to provide an activating, signal. Each touch-less switch has a nominal operating current of around 10 mA. When either 216 touch-less switch is activated the relay in the 216 activates causing the total current goes up to around 50 mA. The activated relay creates a much larger voltage drop across R1 or R10. That voltage drop is sensed in each op amp and amplified to either Q1 64 or Q2 65. The outputs of Q1 and Q2 are summed in diode D4 68 that controls Q3 66. The output of Q4 67 inverts the signal and activates the relay RL1 56 when there is an activation on either of the touch-less sensors 22a, 22b. The output has protection devices Z1 Z2, and Z3 to protect against voltage spikes from the motor and control/controller 14. A fail safe 58 is also provided between the relay 56 and Q4 67. When pins 1 and 2 of the fail safe 58 are jumped, the fail safe is ON When pins 2 and 3 of the fail safe 58 are jumped, the fail safe is OFF.

While the invention has been illustrated and described in detail in the drawings and foregoing description, the same is to be considered as illustrative and not restrictive in character and that all changes and modifications that come within the spirit of the invention are desired to be protected.

Any and all references cited in this specification are incorporated herein by reference to the extent that they supplement, explain, provide a background for or teach methodology or techniques employed herein.

What is claimed is:

1. A kit for replacing a mechanical actuator with a touch-less actuator in a 2-wire activation system comprising:
a touch-less actuator configured for two-wire operation and replacement of an original mechanical actuator of a 2-wire activation system; and
a sensor module connectable to the touch-less actuator, the sensor module configured to sense current in the touch-less actuator and output an activation signal upon sensing a change in current in the touch-less actuator being indicative of user activation of the touch-less actuator.

2. The kit of claim 1, wherein the sensor module includes electrical circuitry to sense an increase in current in the touch-less actuator.

3. The kit of claim 1, wherein the touch-less actuator is configured to use a first amount of current during an idle state, and a second amount of current during activation that is greater than the first amount of current.

4. The kit of claim 3, wherein the sensor module includes a regulator to supply current to an activated touch-less actuator.

5. The kit of claim 4, wherein the first amount of current is around 10 mA and the second amount of current is around 50 mA.

6. The kit of claim 5, wherein the sensor module uses a high-side configured op amp for current sensing.

7. A kit for replacing mechanical actuators in a 2-wire automatic door operating system having a door motor and controller, the kit comprising:
a first touch-less actuator configured for 2-wire operation and replacement of one of the mechanical actuators;
a second touch-less actuator configured for 2-wire operation and replacement of another of the mechanical actuators;
a sensor module connectable to a source of electricity and to the door motor and controller of the automatic door operating system, the sensor module connected to the first and second touch-less actuators and configured to sense a first amount of current during an idle state of either of the touch-less actuators, and a second amount of current during activation of either of the touch-less actuators that is greater than the first amount of current.

8. The kit of claim 7, wherein the sensor module includes a relay in electrical communication with the touch-less actuators such that a relay current is supplied from the relay to an activated touch-less actuator.

9. The kit of claim 8, wherein the first amount of current is around 10 mA and the second amount of current is around 50 mA.

10. The kit of claim 9, wherein the sensor module uses a high-side configured op amp for current sensing.
